(19) United States
(12) Patent Application Publication
(10) Pub. No.: US 2025/0158699 A1
(43) Pub. Date: May 15, 2025

(54) A METHOD FOR CONTROLLING A COVERAGE ENHANCING DEVICE, A COVERAGE ENHANCING DEVICE CONTROLLING NODE AND A COVERAGE ENHANCING DEVICE

(71) Applicant: Sony Group Corporation, Tokyo (JP)

(72) Inventors: Fredrik RUSEK, Eslöv (SE); Erik BENGTSSON, Eslöv (SE); Olof ZANDER, Södra Sandby (SE); Chaitanya TUMULA, Åkarp (SE); Jose FLORDELIS, Lund (SE); Kun ZHAO, Malmö (SE)

(21) Appl. No.: 18/838,405

(22) PCT Filed: Feb. 22, 2023
(86) PCT No.: PCT/EP2023/054411

§ 371 Date: Aug. 14, 2024

(30) Foreign Application Priority Data
Mar. 4, 2022 (SE) 2250293-4

(51) Int. Cl. H04B 7/155; H04W 16/26

(52) U.S. Cl. CPC H04B 7/15528; H04W 16/26

(57) ABSTRACT

A method is disclosed, performed by a coverage enhancing device controlling node, for controlling a coverage enhancing device (CED). The method comprises transmitting, to the CED, a first configuration message, the first configuration message comprising a frequency offset parameter being indicative of a frequency offset to be applied by the CED.

The present disclosure pertains to the field of wireless communications. The present disclosure relates to a method for controlling a coverage enhancing device, a related coverage enhancing device controlling node and a related coverage enhancing device (CED).

### BACKGROUND

Coverage enhancing devices (CED), such as smart repeaters and reflective intelligent surfaces (RIS), can provide coverage enhancement for devices using 5G and beyond. Coverage enhancing devices can be used for beamforming, such as to or from a base station. Coverage enhancing devices can be used to improve signal coverage, for example at hard-to-reach locations, or transitions from outdoors to indoors. Certain coverage enhancing devices can be reconfigurable, such as having the ability to choose a phase shift per coverage enhancing unit cell, such as antenna elements. For given incoming and outgoing angles, an optimal phase setting can be obtained. However, a significant problem is that such phase setting is not limited to reflecting the configured—for incoming and outgoing signal directions but is in fact reflecting a wide range of other directional pairs with the same beamforming gain as for the configured—for incoming and outgoing signal directions. This is because, in general, any input angle has an associated output angle for a specific configuration, herein referred to as parasitic reflections. One unwanted side-effect of CEDs is that they can cause increased interference in a wireless communication system due to the mentioned parasitic reflection, for example, due to a receiver node receiving two superimposed signals, one in a direct link, and one via the CED. These superimposed signals may interfere destructively with each other. This can negatively affect communication by a wireless device in the wireless communication system. The problem may be even larger if the CED applies gain to the reflected signals.

### SUMMARY

Accordingly, there is a need for devices and methods for controlling a coverage enhancing device, which may mitigate, alleviate or address the shortcomings existing and may provide a reduced interference in the wireless communication network and an improved efficiency of the wireless communication network.

A method is disclosed, performed by a coverage enhancing device controlling node, for controlling a coverage enhancing device, CED. The method comprises transmitting, to the CED, a first configuration message, the first configuration message comprising a frequency offset parameter being indicative of a frequency offset to be applied by the CED to signals retransmitted by the CED.

Further, a coverage enhancing device controlling node is disclosed, the coverage enhancing device controlling node comprising memory circuitry, processor circuitry, and a wireless interface, wherein the coverage enhancing device controlling node is configured to perform any of the methods disclosed herein and relating to the coverage enhancing device controlling node

It is an advantage of the present disclosure that a destructive superposition of signals in the wireless communication network can be reduced and the efficiency can be improved by the coverage enhancing device controlling node being able to configure the CED to retransmit a signal originating from a transmitter node frequency translated compared to the original signal received by the CED from the transmitter node. Thereby, the CED can be configured to retransmit the signal in a frequency allocation that does not overlap with the frequency allocation of the direct signal transmitted from the transmitting node.

Thereby, the destructive superposition between the retransmitted signal from the CED and the direct signal from the transmitter node can be reduced or eliminated at a receiver node of the signals. The coverage enhancing device controlling node may thus be configured to control the CED to provide the receiver node with a frequency diversity and spatial diversity of the signal received by the receiver node. Furthermore, by configuring the CED to frequency translate the retransmitted signal using the frequency offset, the retransmitted signal can be identified, by a receiver node, over the original signal transmitted by the transmitter node. This allows the receiver node to identify whether the retransmitted signal or the original signal interferes with other signals received by the receiver node. Based on this identification a scheduling in the wireless communication network may be adapted to reduce interference in the wireless communication network, such as at the receiver node.

A method is disclosed, performed by a coverage enhancing device (CED). The method comprises receiving, from a coverage enhancing device controlling node, a configuration message. The configuration message comprises a frequency offset parameter being indicative of a frequency offset to be applied to a signal received from the coverage enhancing device controlling node. The method comprises applying the frequency offset to signals received from a transmitter node. The method comprises transmitting, to a receiver node, the signals with the applied frequency offset.

Further, a CED is disclosed, the CED comprising memory circuitry, processor circuitry, and a wireless interface, wherein the CED is configured to perform any of the methods disclosed herein and relating to the CED.

It is an advantage of the present disclosure that a destructive superposition of signals in the wireless communication network can be reduced and the efficiency can be improved by the CED being configured by a coverage enhancing device controlling node to retransmit a signal originating from a transmitter node frequency translated compared to the original signal received by the CED from the transmitter node. Thereby, the CED can be configured to retransmit the signal in a frequency allocation that does not overlap with the frequency allocation of the direct signal transmitted from the transmitting node. Thereby, the destructive superposition between the retransmitted signal from the CED and the direct signal from the transmitter node can be reduced or eliminated at a receiver node of the signals. The CED may thus be configured to provide the receiver node with a frequency diversity and spatial diversity of the signal received by the receiver node. Furthermore, the CED being configured to frequency translate the retransmitted signal using the frequency offset, the retransmitted signal can be identified, by a receiver node, over the original signal transmitted by the transmitter node. This allows the receiver node to identify whether the retransmitted signal or the original signal interferes with other signals received by the receiver node. Based on this identification a scheduling in the wireless communication network may be adapted to reduce interference in the wireless communication network.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising example network nodes, an example wireless device and an example coverage enhancing device according to this disclosure,

FIG. 2A-2C are diagrams illustrating respective example frequency contents at various locations in the wireless communication system according to the current disclosure,

FIG. 3 is a flow-chart illustrating an example method, performed in a coverage enhancing device controlling node of a wireless communication system, for controlling a coverage enhancing device according to this disclosure,

FIG. 4 is a flow-chart illustrating an example method, performed in coverage enhancing device according to this disclosure,

FIG. 5 is a block diagram illustrating an example coverage enhancing device controlling node according to this disclosure, and

FIG. 6 is a block diagram illustrating an example coverage enhancing device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

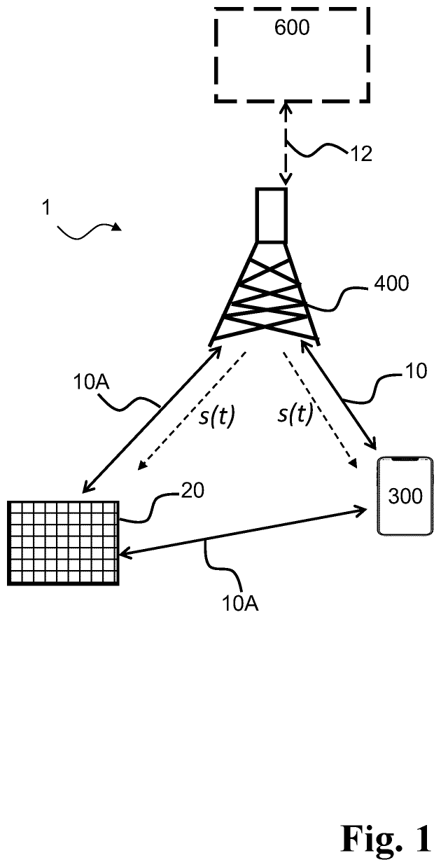

FIG. 1 is a diagram illustrating an example wireless communication system 1 according to this disclosure. The wireless communication system 1 comprises a wireless device 300, a network node 400 and a core network (CN) node 600.

As discussed in detail herein, the present disclosure relates to a wireless communication system 1 comprising a cellular system, for example, a 3GPP wireless communication system.

A network node disclosed herein refers to a radio access network (RAN) node operating in the radio access network, such as a base station, an evolved Node B, eNB, gNB in NR. In one or more examples, the RAN node is a functional unit which may be distributed in several physical units.

The CN node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the CN node is a functional unit which may be distributed in several physical units.

The wireless communication system 1 described herein may comprise one or more wireless devices 300, and/or one or more network nodes 400, such as one or more of a base station, an eNB, a gNB and an access point.

A wireless device may refer to a mobile device and/or a user equipment (UE).

The wireless device 300 may be configured to communicate with the network node 400 via a wireless link (or radio access link) 10.

In one or more examples, the wireless communication system 1 may comprise a coverage enhancing device (CED) 20. The CED 20 may be one or more of a smart repeater, a reflective intelligent surface (RIS) and/or another wireless device (WD). The CED 20 may provide coverage enhancement for devices using 5G and beyond. The CED 20 may be configurable by the network node 400 and may be used to improve signal coverage in the wireless communication system 1. The CED 20 may be used to forward data between the network node 400 and the WD 300 when the WD 300 is located at hard-to-reach locations, such as at a border of a coverage area of the network node 400 or when a direct link between the network node 400 and the WD 300 is obstructed. The WD 300 may be configured to communicate with the network node 400 directly via the wireless link (or radio access link) 10 and/or via the CED 20 via wireless link 10A. The wireless link 10A may herein be referred to as a reflected wireless link. The CED 20 may be controlled by one or more network nodes, such as the network node 400, or one or more wireless devices, such as the WD 300. The one or more network nodes or wireless devices controlling the CED 200 may herein be referred to as coverage enhancing device controlling nodes. In one or more example methods, the coverage enhancing device controlling node can be a CN network node. In one or more example methods, the coverage enhancing device controlling node can be a node in an external network that can access the CED, for example through the internet via a gateway function.

In the example scenario shown in FIG. 1, the WD 300 may receive two superimposed signals, one in the direct wireless link 10, and one via the CED 20 such as via the reflected wireless link 10A. These two signals may combine destructively, which may ultimately lead to a performance degradation compared to if the CED 20 was not present.

According to one or more example scenarios, the network node 400 may transmit a signal s(t) towards a receiver node. In the example scenario shown in FIG. 1, the receiver node is the WD 300. The WD 300 receives the signal both via the direct wireless link 10, such as via a line of sight (LOS) path, and via the CED 20, such as via the reflected wireless link 10A. The received signal r (t) at the WD 300 can, in the absence of noise, within a receive beam at the WD 300 be described as:

$$r ( t ) = s ( t ) * {h}_{0} ( t ) + s ( t ) * {h}_{1} ( t ) ,$$

where h₀(t) is the impulse response of the channel of the direct wireless link 10 and h₁(t) is the impulse response of the reflected wireless link 10A reflected by the CED 20. The impulse response h₁(t) may be influenced by the processing of the signal performed at the CED 20. If the channels are rapidly changing, it may be challenging for the CED 20 to adapt its processing so that the processing at the CED results in constructive combination of h₀(t) and h₁(t). In fact, it could even be the case that the CED 20 degrades the performance of the received signal at the WD 300.

The current disclosure thus provides methods and devices for reducing and/or preventing interference between the two signals received by the WD 300 via the direct wireless link 10 and via the CED 20 via the reflected wireless link 10A. According to the current disclosure, the CED 20 may be configured to perform operations so that the signal arriving at the WD 300 due to the reflected wireless link 10A, such as via the CED 20, is frequency translated compared to the signal received via the direct wireless link 10. The frequency may be translated by performing a frequency translation. The frequency translation may be applied by configuring the CED 20 to perform phase shifts in the time-domain, such as at a baseband sampling rate. This frequency translation of the signal arriving from the CED 20 via the reflected wireless link 10A may be within the same frequency band as the signal received via the direct wireless link 10 but can be arbitrarily changed to a different set of subcarriers than the signal received via the direct wireless link 10.

In one or more example methods, the CED can be configured to apply phase changes at a baseband sample rate basis. This may be a higher rate, such as by several orders of magnitude, than what legacy CEDs can handle. The CED may use its ability to rapidly change its phase pattern to perform frequency translations of the signals forwarded, such as of signals being retransmitted, by the CED. Performing frequency translations herein means that the CED can apply a frequency offset to a received signal being re-transmitted by the CED.

In one or more example methods, let
yₘ(t) be the received signal at the m:th antenna of the CED,
yₘ[n] be samples yₘ(n·Tₛ), n=1, . . . , K, of yₘ(t) taken at a baseband sample rate 1/Tₛ,
n=1, . . . , K, denotes the index of an Orthogonal Frequency Division Multiplexing (OFDM) symbol sample (the CED may, in one or more example methods, denote the start time as n=0),
z_{L}[n] denote an Inverse Fast Fourier Transform (IFFT) of the signal δ[k−L] where δ[k] is a discrete Dirac impulse and L is a number of subcarriers that the signal is to be translated in the frequency domain.

The CED may, in one or more example methods, be configured, for example by a coverage enhancing device controlling node, to apply phase changes to the signal being retransmitted, such as being re-radiated, by the CED according to z_{L}[n]. That is, the re-radiated signal rₘ[n] at antenna m and sample time n will be:

$${r}_{m} [ n ] = {e}^{i {φ}_{m}} {z}_{L} [ n ] {y}_{m} [ n ] , \qquad ( 1 )$$

$$n = 1 , 2 , … , K$$

where K denotes the number of samples in one OFDM symbol and e^{iφm} accounts for spatial beamforming of the CED. Re-radiated may herein also be referred to as retransmitted, such as by a reflective CED, or passed through, such as by a transmissive CED. A reflective CED herein is a CED that reflects an incident signal onto the same half-plane as the signal was received on. By contrast, a transmissive CED lets the incident signal pass through into a half-plane “behind”, such as on the other side of, the CED. This can be useful, for example, for a CED designed to improve outdoor-to-indoor coverage, e.g., having a form-factor of a windowpane.

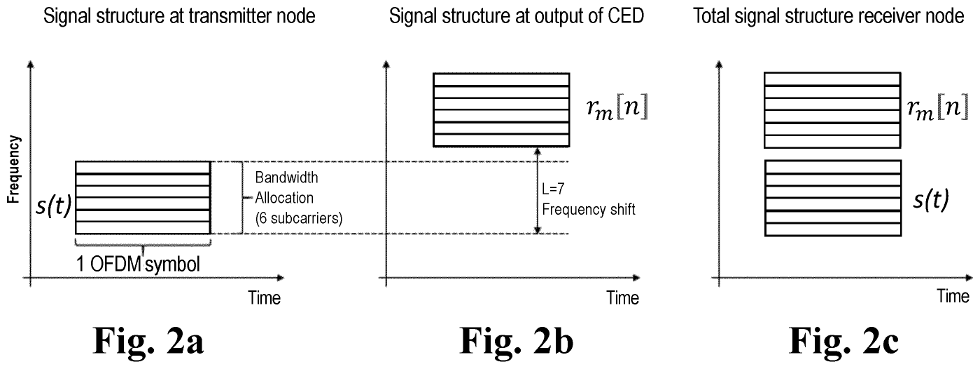

FIG. 2a-2c show an overview of an example frequency content of a signal initially transmitted by a radio network node at various positions in the network, such as in various devices of the network, according to the current disclosure. In the frequency domain, the elementwise multiplication z_{L}[n]yₘ[n] of equation (1) appears as a translation of the frequency content, such as an offset of the frequency content, by exactly L sub-carriers. If L is larger than the number of used sub-carriers in s(t), then the technical effect is that the WD receives the direct link signal and the reflected signal in different parts of the spectrum. In those cases, it is totally irrelevant for the received signal whether h₀(t) and h₁(t) interact constructively or destructively. In fact, h₀(t) and h₁(t) may not interact at all since they are received at different frequency bands. According to FIG. 2a, a radio network node, such as the radio network node 400 of FIG. 1, may transmit the signal s(t) in a first frequency allocation, such as a first bandwidth allocation. The first frequency allocation may comprise a number of subcarriers. In the example frequency allocation shown in FIG. 2a, the first frequency allocation comprises 6 subcarriers. The signal transmitted in the first frequency allocation corresponds to the signal received by the CED from the radio network node and to the signal received by the WD via the direct wireless link from the radio network node. FIG. 2b shows the frequency content of the signal retransmitted by the CED after the CED has performed the frequency translation of the signal received from the radio network node. The frequency translation may be performed using equation 1 above. The signal shown in FIG. 2b thus corresponds to the re-radiated signal rₘ[n]. In the example shown in FIG. 2b, the re-radiated signal transmitted by the CED has been frequency shifted by L=7 subcarriers from the input signal received from the radio network node. Since FIG. 2c shows the total signal structure as received by the WD. The total signal comprises the signal received directly from the radio network node, such as via the direct wireless link, and the re-radiated signal received from the CED. Since the frequency shift L for the retransmitted signal rₘ[n] is larger than the number of used subcarriers for the signal s(t), the frequency allocations of the direct signal s(t) and the retransmitted signal rₘ[n] do not overlap, and therefore do not interact with each other.

Hence, by frequency translating the retransmitted signal the interference between the direct signal s(t) and the retransmitted signal rₘ[n] may be reduced and/or prevented.

The frequency translation functionality, such as the frequency offset functionality, at CEDs may, in one or more example methods, be applied for scheduling purposes in a network to reduce interference seen by a second WD. The second WD may be a WD different than the WD receiving the signal s(t) from the radio network node. In other words, the second WD may be a WD not being a receiving node of the transmitted signal s(t).

In one or more example methods, whenever a CED is turned on, or is reconfigured, the second WD may be informed, for example by the radio network node sending the signal s(t), about a possible change of interference properties. A radio network node serving a first WD, such as the WD 300, both via the direct wireless link and via the CED may potentially create interference to the second WD (in an arbitrary cell). For scheduling purposes, it is of interest for the radio network node to know whether it is the direct wireless link, such as the direct wireless link 10 in FIG. 1, or the reflected wireless link via the CED, such as the reflected wireless link 10A in FIG. 1, that interferes with the second WD. To obtain said information, the radio network node may, in one or more example methods, transmit a reference signal in a first frequency band. The reference signal may be transmitted in an arbitrary cell of the radio network node. A coverage enhancing device controlling node, such as the radio network node, may then configure the CED to perform a frequency translation of the retransmitted signal, and request the second WD to monitor both frequency bands. Upon receiving a report, such as a cross-link interference (CLI) report or an interference measurement (IM) report, from the second WD, the radio network node may acquire information about which wireless link that is causing interference at the second WD. Based on the acquired information, the radio network node may schedule the signaling to reduce the interference experienced in the wireless communications network, such as interference experienced by the second WD. The solution according to this disclosure may thus provide frequency diversity and/or spatial diversity of signals transmitted within a network without the need for exchanging data over a backhaul link.

Although the examples described in FIG. 1 and FIG. 2 relate to the frequency translation being performed on downlink signals, such as when the signal originates from a radio network node and is transmitted to a WD, the methods disclosed herein are also applicable for uplink signals and/or sidelink signals. In the downlink scenario shown in FIG. 1, the signals upon which the frequency translation is to be performed originate from the network; the radio network node is thus a transmitter node and the WD is a receiver node of the signals. Uplink signals herein means signals originating from a WD and being transmitted to a radio network node. Hence, in uplink the transmitter node of the signal upon which the frequency translation is to be performed is a WD and the receiver node is a radio network node. Sidelink herein means signals transmitted between two WDs, such as signals originating from a first WD and being transmitted to a second WD. Hence, in sidelink the transmitter node of the signals upon which the frequency translation is to be performed is a first WD and the receiver node is a second WD. In one or more example methods, the uplink signals and the downlink signals may be transmitted via a 5G air interface, such as via a Uu interface. In one or more example methods, the sidelink signals may be transmitted via a communication interface for communicating between devices, such as via a PC5 interface.

In one or more example methods, initial control signaling, such as the configuration messages, may be transmitted by a coverage enhancing device controlling node. The coverage enhancing device controlling node may be a WD or a network node, irrespective of whether the signal upon which the frequency translation is to be performed is transmitted in uplink, downlink and/or sidelink. In one or more example methods, the coverage enhancing device controlling node may be a network node, such as a radio network node or a core network node.

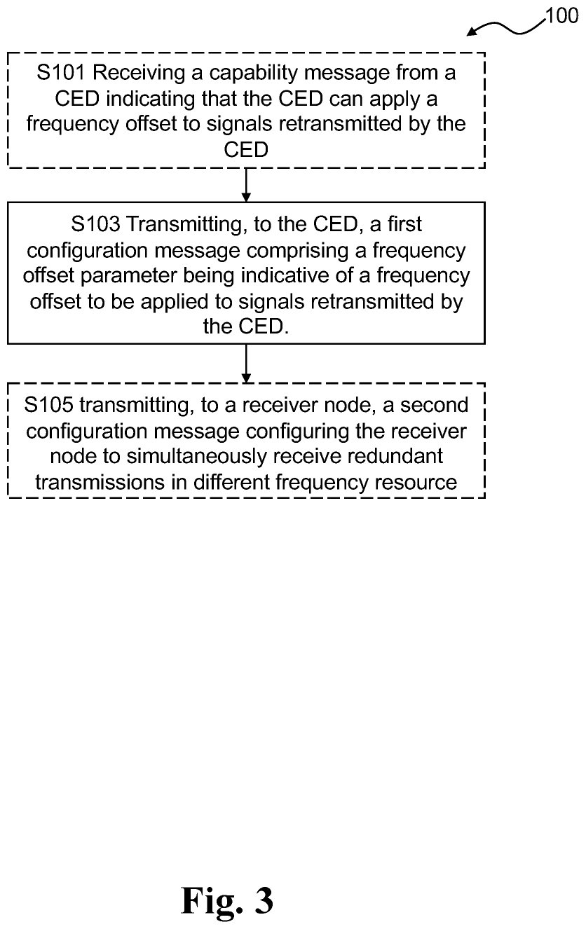

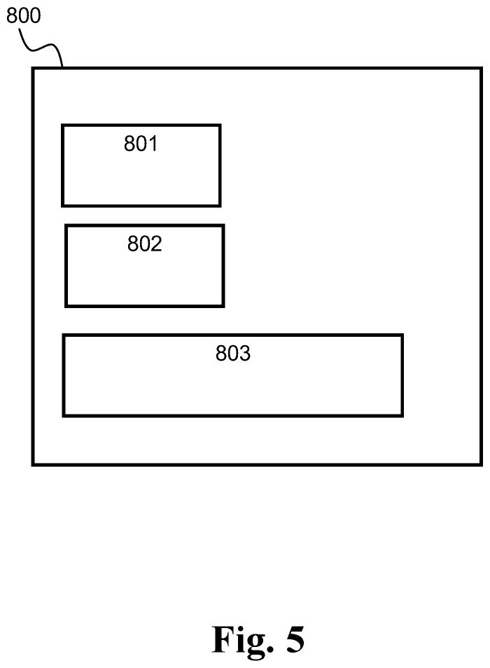

FIG. 3 shows a flow diagram of an example method 100, performed by a coverage enhancing device controlling node according to the disclosure, for controlling a CED. The coverage enhancing device controlling node may be a network node and/or a wireless device disclosed herein and being configured to control the CED, such as the network node 400 and/or the wireless device 300 of FIG. 1, and FIG. 5.

In one or more example methods, the method comprises receiving S101, from the CED, a capability message indicating that the CED can apply a frequency offset to the signals received and retransmitted by the CED. The capability message may for example comprise an indication indicating that the CED is capable of applying, such as being configured to apply, phase changes at a baseband sample rate basis. Being capable of applying herein means that the CED has a hardware and/or software configuration allowing the CED to apply phase changes at the baseband sample rate. The sample rate of a signal is the average number of samples obtained of the signal in one second when the signal is reduced from a continuous-time signal to a discrete-time signal. The baseband sample rate may be in the range of MHz to THz, such as in the range of 1 MHZ to 2000 MHz, such as 1.4 MHZ, 10 MHZ, 20 MHZ, 100 MHz and/or 400 MHZ. The CED may in one or more example methods be a CED, such as a large intelligent surface (LIS) as disclosed by Ertugrul Basar, “Transmission Through Large Intelligent Surfaces: A New Frontier in Wireless Communications”, arXiv: 1902.08463v2, 2019.

In one or more example methods, the capability message comprises an indication of a frequency band supported by the CED. The indication may, in one or more example methods, be indicative of a configurable frequency band, such as a dynamically configurable frequency range, of the CED. In one or more example methods, the indication may be indicative of a maximum frequency range and/or a minimum frequency range supported by the WD. In one or more example methods, the indication may be indicative of a configurability range, such as a configurable frequency range, supported by the WD.

The method 100 comprises transmitting S103, to the CED, a first configuration message, the first configuration message comprising a frequency offset parameter being indicative of a frequency offset to be applied by the CED to signals retransmitted, such as forwarded, by the CED. In one or more example methods, the frequency offset parameter corresponds to the parameter L of Equation 1. The first configuration message can, in one or more example methods, configure the CED to perform a frequency translation of the signal retransmitted by the CED. The frequency offset parameter may be indicative of an offset to be applied to a frequency translation of the signal retransmitted by the CED. The offset may be in relation to the frequency allocation of the signal received from the radio network node to be retransmitted by the CED. In one or more example methods, the CED may forward signals born on any type of physical channel and/or signal, such as on downlink and/or uplink. In one more example methods, the frequency offset may be applied to signals transmitted on a Physical Downlink Shared Channel (PDSCH). The retransmitted signal may be a signal received from a radio network node on the PDSCH and being forwarded to the WD by the CED. The first configuration message may be a Downlink Control Information (DCI) message.

In one or more example methods, the frequency offset parameter is indicative of an offset of an absolute frequency value, such as an absolute value in Hertz (Hz), that the retransmitted signal is to be translated with. In one or more example methods, the frequency offset parameter is indicative of one or more of an offset of a number of subcarriers and a subcarrier spacing that the retransmitted signal is to be frequency translated with. In one or more example methods, the frequency offset parameter is indicative of a resource block (RB) that the retransmitted signal is to be frequency translated with. In one or more example methods, the frequency offset parameter is indicative of a resource element (RE) and a subcarrier spacing that the retransmitted signal is to be frequency translated with.

In one or more example methods, the first configuration message comprises a duration parameter being indicative of a duration for which the frequency offset is to be applied to the signals retransmitted by the CED. The duration may be a time duration or a number of samples for which the CED is to apply the frequency translation based on the frequency offset. In one or more example methods, the duration is indicated as one or more of a number of symbols, such as a number of Orthogonal frequency division multiplexing (OFDM) symbols, and a number of slots, such as a number of 5G NR slots. In other words, the duration parameter may be indicative of the number of symbols and/or slots.

In one or more example methods, the duration parameter is indicative of a start time at which the frequency offset is to be applied, such as a start time at which the CED is to start performing the frequency translation of the retransmitted signal. In one or more example methods, the start time may be given by a start time parameter comprised in the first configuration message. The start time may, in one or more example methods, correspond to an instant of Equation 1, e.g., n=1. The start time may be given, e.g., as a number of slots and/or OFDM symbols after the start of the slot in which the first configuration message, such as a (re) configuration command was received.

In one or more example methods, the first configuration message comprises a pattern indicator indicating a pattern, such as a temporal pattern, in which the frequency offset is to be applied. A temporal pattern herein means a pattern over time. The first configuration message may thus configure the CED to perform the frequency translation based on the pattern. In one or more example methods, the pattern indicator indicates that the frequency offset is to be applied to uplink and/or downlink signals. The first configuration message may for example indicate whether the frequency translation is to be performed only for uplink signals, only for downlink signals, or for both uplink and downlink signals. In one or more example methods, the pattern indicator may indicate that the frequency translation is to be performed for certain types of signaling, such as for signaling on one or more of the PDSCH, a Physical Uplink Shared Channel (PUSCH), a Physical Uplink Control Channel (PUCCH), and a Physical Downlink Control Channel (PDCCH). In one or more example methods, the pattern indicator may indicate that the frequency translation is not to be performed for certain types of signaling, such as for signaling on one or more of the PDSCH, the PUSCH, the PUCCH, and the PDCCH. In one or more example methods, the pattern is synchronized to slots of a channel, such as to one or more uplink slots, such as to PUSCH slots and/or PUCCH slots, and/or to one or more downlink slots, such as to PDSCH slots and/or PDCCH slots of the channel. A slot herein refers to an OFDM slot. A PUSCH slot herein means a slot carrying a PUSCH. A PUCCH slot herein means a slot carrying a PUCCH. A PDSCH slot herein means a slot carrying a PDSCH. A PDCCH slot herein means a slot carrying a PDCCH.

In one or more example methods, the pattern indicator may indicate that a retransmission of a signal received from the radio network node is not to be performed for certain types of signaling, such as for signaling on one or more of the PDSCH, the PUSCH, the PUCCH, and the PDCCH. In one or more example methods, the first configuration message may thus configure the CED to retransmit and/or frequency translate only certain signaling based on the pattern indicator.

In one or more example methods, the method comprises transmitting S105, to a receiver node, a second configuration message configuring the receiver node to simultaneously receive redundant transmissions in different frequency resources. In one or more example methods, the second configuration message may indicate that the CED can and/or will apply a frequency offset to a signal retransmitted from the CED to the receiver node. The second configuration message may thus indicate to the receiver node that the same data will appear twice and may also indicate the frequency location of the data. The second configuration message may thus enable the receiver node to decode the data in the received signal based on the redundant information. The second configuration message may be a DCI message. The receiver node may be a WD and/or a radio network node being the intended receiver of the retransmitted signal. The redundant data retransmitted from the CED provides frequency diversity and spatial diversity to the receiver node, such as to a receiving WD, without any data transfer required over a backhaul in the wireless communication network as in conventional systems, such as in legacy systems.

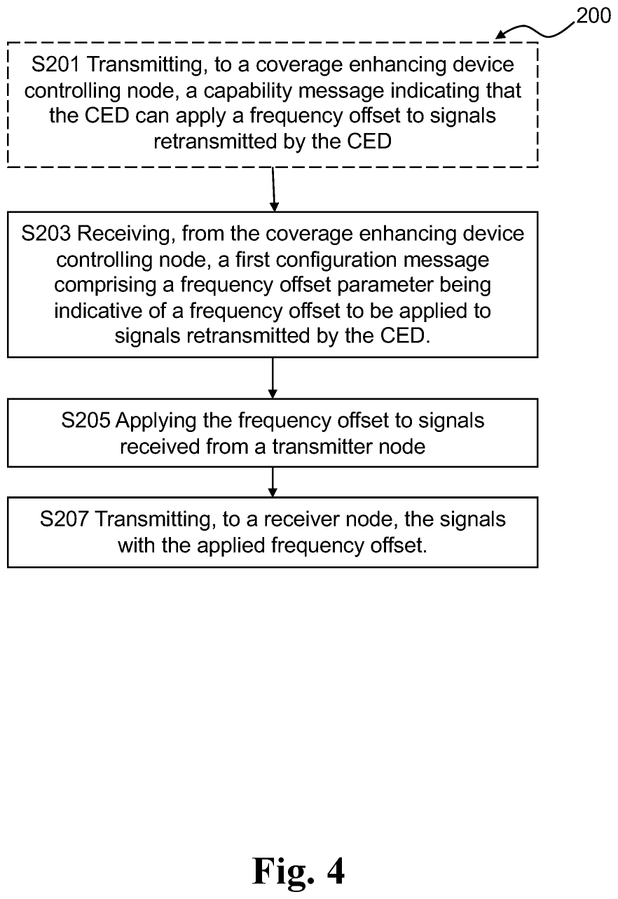

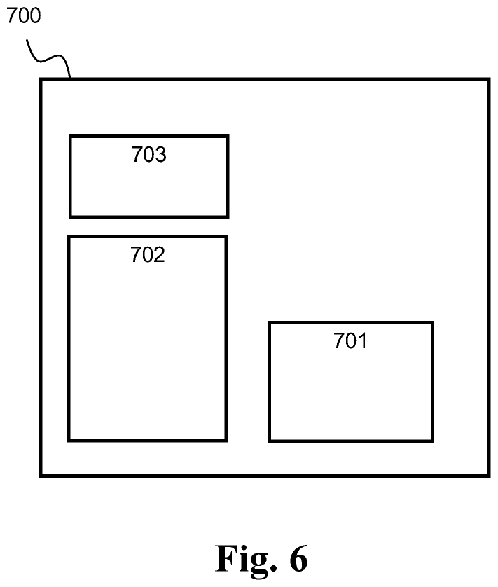

FIG. 4 shows a flow diagram of an example method 200, performed by a CED according to the disclosure. The coverage enhancing device may be the CED disclosed herein, such as the CED 20 of FIG. 1, and FIG. 6.

In one or more example methods, the method comprises transmitting S201, to the coverage enhancing device controlling node, a capability message indicating that the CED can apply a frequency offset to the signals received and retransmitted by the CED. The coverage enhancing device controlling node may be any node configured to control the CED, such as one or more of a radio network node and a WD. The capability message may for example comprise an indication indicating that the CED is capable of applying, such as being configured to apply, phase changes at a baseband sample rate basis. Being capable of applying herein means that the CED has a hardware and/or software configuration allowing the CED to apply phase changes at the baseband sample rate. In one or more example methods, the capability message comprises an indication of a frequency band supported by the CED. The indication may, in one or more example methods, be indicative of a configurable frequency band, such as a dynamically configurable frequency range, of the CED. In one or more example methods, the indication may be indicative of a maximum frequency range and/or a minimum frequency range supported by the WD. In one or more example methods, the indication may be indicative of a configurability range, such as a configurable frequency range, supported by the WD.

The method 200 comprises receiving S203, from the coverage enhancing device controlling node, a configuration message comprising a frequency offset parameter being indicative of a frequency offset to be applied to a signal received from the coverage enhancing device controlling node. In one or more example methods, the frequency offset parameter corresponds to the parameter L of Equation 1. The first configuration message can, in one or more example methods, configure the CED to perform a frequency translation of the signal received by the CED before retransmitting, such as forwarding the signal. The frequency offset parameter may be indicative of an offset to be applied to a frequency translation of the signal received from the network node retransmitted by the CED. The offset may be in relation to the frequency allocation of the signal received from the radio network node to be retransmitted by the CED. In one more example methods, the frequency offset may be applied to signals transmitted on the PDSCH. The retransmitted signal may be a signal received from a radio network node on the PDSCH and being forwarded to a receiver node, such as to a WD in downlink or in sidelink or to a radio network node in uplink, by the CED. The first configuration message may be a DCI message. The configuration message received from the coverage enhancing device controlling node corresponds to the first configuration message transmitted by the coverage enhancing device controlling node.

In one or more example methods, the frequency offset parameter is indicative of an offset of an absolute frequency value, such as an absolute value in Hertz (Hz), that the retransmitted signal is to be translated with. In one or more example methods, the frequency offset parameter is indicative of one or more of an offset of a number of subcarriers and a subcarrier spacing that the retransmitted signal is to be frequency translated with. In one or more example methods, the frequency offset parameter is indicative of one or more of a resource block (RB) and a resource element (RE) that the retransmitted signal is to be frequency translated with.

In one or more example methods, the configuration message comprises a duration parameter being indicative of a duration of time during which the frequency offset is to be applied to signals received by the CED. The duration may be a time duration or a number of samples for which the CED is to apply the frequency translation based on the frequency offset. In one or more example methods, the duration is indicated as one or more of a number of symbols, such as a number of OFDM symbols, and a number of slots, such as a number of OFDM slots. In other words, the duration parameter may be indicative of the number of symbols and/or slots.

In one or more example methods, the duration parameter is indicative of a start time at which the frequency offset is to be applied, such as a start time at which the CED is to start performing the frequency translation of the retransmitted signal. The start time may, in one or more example methods, correspond to the instant of Equation 1, such as e.g., n=1. The start time parameter may be given, e.g., as a number of slots and/or OFDM symbols after the start of the slot in which the first configuration message, such as a (re) configuration command was received.

In one or more example methods, the configuration message comprises a pattern indicator indicating a pattern, such as a temporal pattern, in which the frequency offset is to be applied. The first configuration message may thus configure the CED to perform the frequency translation based on the pattern. In one or more example methods, the pattern indicator indicates that the frequency offset is to be applied to uplink and/or downlink signals. The first configuration message may for example indicate whether the frequency translation is to be performed only for uplink signals, only for downlink signals, or for both uplink and downlink signals. In one or more example methods, the pattern indicator may indicate that the frequency translation is to be performed for certain types of signals, such as for signals on one or more of the PDSCH, the PUSCH, the PUCCH, and the PDCCH. In one or more example methods, the pattern indicator may indicate that the frequency translation is not to be performed for certain types of signals, such as for signals on one or more of the PDSCH, the PUSCH, the PUCCH, and PDCCH. In one or more example methods, the pattern is synchronized to slots of a channel, such as to one or more uplink slots, such as to PUSCH slots and/or PUCCH slots, and/or to one or more downlink slots, such as to PDSCH slots and/or PDCCH slots of the channel. A slot herein refers to an OFDM slot.

In one or more example methods, the pattern indicator may indicate that a retransmission of a signal received from the radio network node is not to be performed for certain types of signaling, such as for signaling on one or more of the PDSCH, the PUSCH, the PUCCH, and the PDCCH. In one or more example methods, the configuration message may thus configure the CED to retransmit and/or frequency translate only certain signaling based on the pattern indicator.

The method 200 comprises applying S205 the frequency offset to signals received from a transmitter node. The transmitter node may be the coverage enhancing device controlling node or a different node transmitting the signal. In one or more example methods, such as when the signal is a downlink signal, the transmitter node is a radio network node. In one or more example methods, such as when the signal is an uplink signal, the transmitter node is a WD. In one or more example methods, such as when the signal is a sidelink signal, the transmitter node is a WD.

The method 200 comprises transmitting S207, to a receiver node, the signals with the applied frequency offset. In one or more example methods, applying the frequency offset comprises frequency translating the signal using the indicated frequency offset. In other words, transmitting S207 may comprise retransmitting the received signal with a frequency translation according to the frequency offset indicated in the configuration message. In one or more example methods, such as when the signal is a downlink signal, the receiver node is a WD. In one or more example methods, such as when the signal is an uplink signal, the receiver node is a radio network node. In one or more example methods, such as when the signal is a sidelink signal, the receiver node is a WD.

FIG. 5 shows a block diagram of an example coverage enhancing device controlling node 800 according to the disclosure, such as the radio network node 400 or the WD 300 disclosed in FIG. 1. The coverage enhancing device controlling node 800 comprises memory circuitry 801, processor circuitry 802, and a wireless interface 803. The coverage enhancing device controlling node 800 may be configured to perform any of the methods disclosed in FIG. 3. In other words, the network node 400 may be configured for controlling a CED.

The coverage enhancing device controlling node 800 is configured to transmit, to the CED, a first configuration message, the first configuration message comprising a frequency offset parameter being indicative of a frequency offset to be applied by the CED to signals retransmitted by the CED. The coverage enhancing device controlling node 800 may be configured to transmit the first configuration message via the wireless interface 803.

The wireless interface 803 is configured for wireless communications via a wireless communication system, such as a 3GPP system, such as a 3GPP system supporting one or more of: New Radio, NR, Narrow-band IoT, NB-IoT, Non-Terrestrial Network (NTN), reduced capability (RedCap), Long Term Evolution (LTE), and Long Term Evolution-enhanced Machine Type Communication, LTE-M, millimeter-wave communications, such as millimeter-wave communications in licensed and/or unlicensed bands, such as device-to-device millimeter-wave communications in licensed and/or unlicensed bands.

Processor circuitry 802 is optionally configured to perform any of the operations disclosed in FIG. 3 (such as any one or more of S101, S103, S105). The operations of the overage enhancing device controlling node 800 may be embodied in the form of executable logic routines (for example, lines of code, software programs, etc.) that are stored on a non-transitory computer readable medium (for example, memory circuitry 801) and are executed by processor circuitry 802).

Furthermore, the operations of the coverage enhancing device controlling node 800 may be considered a method that the coverage enhancing device controlling node 800 is configured to carry out. Also, while the described functions and operations may be implemented in software, such functionality may also be carried out via dedicated hardware or firmware, or some combination of hardware, firmware and/or software.

Memory circuitry 801 may be one or more of a buffer, a flash memory, a hard drive, a removable media, a volatile memory, a non-volatile memory, a random access memory (RAM), or other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 5). Memory circuitry 801 is considered a non-transitory computer readable medium. The memory circuitry 801 may store instructions that when executed by the processor circuitry 802 causes the coverage enhancing device controlling node 800 to perform the method disclosed in FIG. 3.

Memory circuitry 801 may be configured to store information, such as frequency translation information, frequency offset parameter information, duration parameter information, pattern information, and/or CED capability information, in a part of the memory.

FIG. 6 shows a block diagram of an example CED 700 according to the disclosure. The CED 700 comprises memory circuitry 701, processor circuitry 702, and a wireless interface 703. The CED 700 may be configured to perform any of the methods disclosed in FIG. 4.

The CED 700 is configured to receive (such as via the wireless interface 703) from a coverage enhancing device controlling node, a configuration message, wherein the configuration message comprises a frequency offset parameter being indicative of a frequency offset to be applied to a signal received from the coverage enhancing device controlling node.

The CED 700 is configured to apply (such as using the processor circuitry 702), the frequency offset to signals received from a transmitter node.

The CED 700 is configured to transmit (such as via the wireless interface 703), to a receiver node, the signals with the applied frequency offset.

The wireless interface 703 is configured for wireless communications via a wireless communication system, such as a 3GPP system, such as a 3GPP system supporting one or more of: New Radio, NR, Narrow-band IoT, NB-IoT, Non-Terrestrial Network (NTN), reduced capability (RedCap), Long Term Evolution (LTE), and Long Term Evolution-enhanced Machine Type Communication, LTE-M, millimeter-wave communications, such as millimeter-wave communications in licensed and/or unlicensed bands, such as device-to-device millimeter-wave communications in licensed and/or unlicensed bands.

The CED 700 is optionally configured to perform any of the operations disclosed in FIG. 4 (such as any one or more of S201, S203, S205, S207). The operations of the CED 700 may be embodied in the form of executable logic routines (for example, lines of code, software programs, etc.) that are stored on a non-transitory computer readable medium (for example, memory circuitry 701) and are executed by processor circuitry 702).

Furthermore, the operations of the CED 700 may be considered a method that the CED 700 is configured to carry out. Also, while the described functions and operations may be implemented in software, such functionality may also be carried out via dedicated hardware or firmware, or some combination of hardware, firmware and/or software.

Memory circuitry 701 may be one or more of a buffer, a flash memory, a hard drive, a removable media, a volatile memory, a non-volatile memory, a random access memory (RAM), or other suitable device. In atypical arrangement, memory circuitry 701 may include a non-volatile memory for long term data storage and a volatile memory that functions as system memory for processor circuitry 702. Memory circuitry 301 may exchange data with processor circuitry 302 over a data bus. Control lines and an address bus between memory circuitry 701 and processor circuitry 702 also may be present (not shown in FIG. 6). Memory circuitry 701 is considered a non-transitory computer readable medium. The memory circuitry 701 may store instructions that when executed by the processor circuitry 702 causes the CED 700 to perform the method disclosed in FIG. 4.

Memory circuitry 701 may be configured to store information, such as frequency translation information, frequency offset parameter information, duration parameter information, pattern information, and/or CED capability information, in a part of the memory.

Examples of methods and products (network node and wireless device) according to the disclosure are set out in the following items:
Item 1. A method performed by a coverage enhancing device controlling node, for controlling a coverage enhancing device, CED, wherein the method comprises:
   transmitting (S103), to the CED, a first configuration message, the first configuration message comprising a frequency offset parameter being indicative of a frequency offset to be applied by the CED to signals retransmitted by the CED.
Item 2. The method according to Item 1, wherein the first configuration message comprises a duration parameter being indicative of a duration during which the frequency offset is to be applied to the signals retransmitted by the CED.
Item 3. The method according to Item 2, wherein the duration is indicated as one or more of a number of symbols and a number of slots.
Item 4. The method according to Item 2 or 3, wherein the duration parameter is indicative of a start time at which the frequency offset is to be applied.
Item 5. The method according to any one of the previous Items, wherein the frequency offset parameter is indicative of an offset of an absolute frequency value.
Item 6. The method according to any one of the previous Items, wherein the frequency offset parameter is indicative of one or more of an offset of a number of subcarriers and a subcarrier spacing.
Item 7. The method according to any one of the previous Items, wherein the frequency offset parameter is indicative of one or more of a resource block and a resource element.
Item 8. The method according to any one of the previous Items, wherein the first configuration message comprises a pattern indicator indicating a pattern in which the frequency offset is to be applied.
Item 9. The method according to Item 8, wherein the pattern indicator indicates that the frequency offset is to be applied to uplink and/or downlink signalling.
Item 10. The method according to any one of the previous Items, wherein the method comprises:
   receiving (S101), from the CED, a capability message indicating that the CED can apply the frequency offset to the signals retransmitted by the CED.
Item 11. The method according to Item 10, wherein the capability message comprises an indication of a frequency band supported by the CED.
Item 12. The method according to any one of the previous Items, wherein the method comprises:
   transmitting (S105), to a receiver node, a second configuration message configuring the receiver node to simultaneously receive redundant transmissions in different frequency resource.
Item 13. A method, performed by a coverage enhancing device, CED, the method comprising:
   receiving (S203), from a coverage enhancing device controlling node, a configuration message, wherein the configuration message comprises a frequency offset parameter being indicative of a frequency offset to be applied to a signal received from the coverage enhancing device controlling node,
   applying (S205) the frequency offset to signals received from a transmitter node, and
   transmitting (S207), to a receiver node, the signals with the applied frequency offset.
Item 14. The method according to Item 13, wherein the configuration message comprises a duration parameter being indicative of a duration during which the frequency offset is to be applied to signals received by the CED.
Item 15. The method according to Item 14, wherein the duration is indicated as one or more of a number of symbols and a number of slots.
Item 16. The method according to any one of the Items 14-15, wherein the duration parameter is indicative of a start time at which the indicated frequency offset is to be applied.
Item 17. The method according to any one of the Items 13-16, wherein the frequency offset parameter is indicative of an offset of an absolute frequency value.
Item 18. The method according to any one of the Items 13-17, wherein the frequency offset parameter is indicative of one or more of an offset of a number of subcarriers and a subcarrier spacing.
Item 19. The method according to any one of the Items 13-18, wherein the frequency offset parameter is indicative of one or more of a resource block and a resource element.
Item 20. The method according to any one of the Items 13-19, wherein the configuration message comprises a pattern indicator indicating a pattern in which the frequency offset is to be applied.
Item 21. The method according to Item 20, wherein the pattern indicator indicates that the frequency offset is to be applied to uplink and/or downlink signaling.
Item 22. The method according to any one of the Items 13-21, wherein the method comprises:
   transmitting (S201), to the coverage enhancing device controlling node, a capability message indicating that the CED can apply the frequency offset to signals retransmitted by the CED.
Item 23. The method according to Item 22, wherein the capability message comprises an indication of a frequency band supported by the CED.
Item 24. A coverage enhancing device controlling node comprising memory circuitry, processor circuitry, and a wireless interface, wherein the CED controlling node is configured to perform any of the methods according to any of Items 1-12.
Item 25. A coverage enhancing device, CED, comprising memory circuitry, processor circuitry, and a wireless interface, wherein the CED is configured to perform any of the methods according to any of Items 13-23.

The use of the terms “first”, “second”, “third” and “fourth”, “primary”, “secondary”, “tertiary” etc. does not imply any particular order but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that FIGS. 1-6 comprise some circuitries or operations which are illustrated with a solid line and some circuitries, components, features, or operations which are illustrated with a dashed line. Circuitries or operations which are comprised in a solid line are circuitries, components, features, or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a coverage enhancing device controlling node, for controlling a coverage enhancing device (CED), wherein the method comprises:
transmitting, to the CED, a first configuration message, the first configuration message comprising a frequency offset parameter being indicative of a frequency offset to be applied by the CED to signals retransmitted by the CED.

2. The method according to claim 1, wherein the first configuration message comprises a duration parameter being indicative of a duration during which the frequency offset is to be applied to the signals retransmitted by the CED.

3. The method according to claim 2, wherein the duration is indicated as one or more of a number of symbols and a number of slots.

4. The method according to claim 2, wherein the duration parameter is indicative of a start time at which the frequency offset is to be applied.

5. The method according to claim 1, wherein the frequency offset parameter is indicative of an offset of an absolute frequency value.

6. The method according to claim 1, wherein the frequency offset parameter is indicative of one or more of an offset of a number of subcarriers and a subcarrier spacing.

7. The method according to claim 1, wherein the frequency offset parameter is indicative of one or more of a resource block and a resource element.

8. The method according to claim 1, wherein the first configuration message comprises a pattern indicator indicating a pattern in which the frequency offset is to be applied.

9. The method according to claim 8, wherein the pattern indicator indicates that the frequency offset is to be applied to uplink and/or downlink signaling.

10. The method according to claim 1, wherein the method comprises:
receiving, from the CED, a capability message indicating that the CED can apply the frequency offset to the signals retransmitted by the CED.

11. The method according to claim 10, wherein the capability message comprises an indication of a frequency band supported by the CED.

12. The method according to claim 1, wherein the method comprises:
transmitting, to a receiver node, a second configuration message configuring the receiver node to simultaneously receive redundant transmissions in different frequency resource.

13. A method, performed by a coverage enhancing device (CED), the method comprising:
receiving, from a coverage enhancing device controlling node, a configuration message, wherein the configuration message comprises a frequency offset parameter being indicative of a frequency offset to be applied to a signal received from the coverage enhancing device controlling node,
applying the frequency offset to signals received from a transmitter node, and
transmitting, to a receiver node, the signals with the applied frequency offset.

14. The method according to claim 13, wherein the configuration message comprises a duration parameter being indicative of a duration during which the frequency offset is to be applied to signals received by the CED.

15. The method according to claim 14, wherein the duration is indicated as one or more of a number of symbols and a number of slots.

16. The method according to claim 14, wherein the duration parameter is indicative of a start time at which the indicated frequency offset is to be applied.

17. The method according to claim 13, wherein the frequency offset parameter is indicative of an offset of an absolute frequency value.

18. The method according to claim 13, wherein the frequency offset parameter is indicative of one or more of an offset of a number of subcarriers and a subcarrier spacing.

19. The method according to claim 13, wherein the frequency offset parameter is indicative of one or more of a resource block and a resource element.

20. The method according to claim 13, wherein the configuration message comprises a pattern indicator indicating a pattern in which the frequency offset is to be applied.

21-25. (canceled)
